(19) United States
(12) Patent Application Publication
(10) Pub. No.: US 2015/0212223 A1
(43) Pub. Date: Jul. 30, 2015

(54) METHODS AND APPARATUS FOR DETERMINING RESIDUAL STATIC CORRECTIONS USING INDIVIDUAL RANGES

(71) Applicant: CGG Services SA, Massy Cedex (FR)

(72) Inventor: Guillaume POULAIN, Montrouge (FR)

(21) Appl. No.: 14/598,500

(22) Filed: Jan. 16, 2015

Related U.S. Application Data
(60) Provisional application No. 61/932,273, filed on Jan. 28, 2014.

(51) Int. Cl. G01V 1/36

(52) U.S. Cl. CPC G01V 1/362; G01V 2210/53; G01V 2210/74

(57) ABSTRACT

Methods and apparatuses calculate residual static corrections to be applied to survey data to account for upper-layer effects, such that the residual static corrections are each within an individual range for a location, with the individual range being determined using in-field non-survey-acquired information.

### CROSS REFERENCE TO RELATED APPLICATIONS

This application claims priority and benefit from U.S. Provisional Patent Application No. 61/932,273, filed Jan. 28, 2014, for “Variable Range in Residual Reflexion Static Estimation,” the entire content of which is incorporated in its entirety herein by reference.

### BACKGROUND

1. Technical Field

Embodiments of the subject matter disclosed herein generally relate to determining residual static corrections that account for local effects due to the top layer, around a source or a receiver location, for survey data acquired to explore an underground formation.

2. Discussion of the Background

In geophysical prospecting, gas and oil reservoirs are sought by performing surveys of underground formations, using variations of wave propagation velocity from one layer to another. Reflected, refracted and transmitted waves are detected by seismic receivers after traveling through the explored underground formation. Surveys are performed on land and in water, most frequently using seismic waves.

Survey data can be strongly affected by heterogeneities of the near-surface layer (known as the weathering zone). Indeed, the thickness and the wave velocity inside this layer can vary a lot according to the surface material (consolidated rock, unconsolidated sediments, mud, sand, etc.) and the weathering conditions (water table elevation, temperatures, etc.). Velocities at which waves propagate in the weathering zone are generally lower than wave velocities in deeper layers (even some velocity inversion is, for example, possible in case of permafrost). The wave velocity in the weathering zone can vary from 100 m/s to 7000 m/s and the thickness can vary from a few meters to 200 m. As a consequence, the time required by the seismic wave to travel through the weathering zone strongly depends on the position of each source or receiver. These travel time differences deteriorate the lateral coherency of seismic events in the stack section. Trajectories are generally assumed close to vertical direction in the weathering zone and some residual statics corrections (e.g. time shifts) are then computed to remove the weathering zone effect.

A trace 100 along which a wave emitted from source 110 travels to receiver 120 is illustrated in FIG. 1. Velocity v1 in the weathering layer 130 is much smaller than velocity v2 of the layer 140, under the weathering layer. Trace 100 (or any other traces of waves emitted from the same source location) is corrected by a (first) residual static correction (e.g., a time shift). Trace 100 (or any other traces of waves detected at the same receiver location) is also corrected by another (second) residual static correction. In other words, a residual correction is associated with a location (of a shot or of a receiver) not with a trace. Conversely, two static corrections are applied to a trace: a first one related to the shot location and a second one related to the receiver location.

The problem of residual static corrections has been identified in the early days of the seismic surveys. Since the 1970s, many computational methods for determining these residual static corrections have been developed. These conventional methods generally use cross-correlation techniques to estimate the residual static corrections. More recently, some stochastic approaches based on the stack power have started being used to estimate these corrections. These conventional methods require an initial maximum for the absolute values of residual static corrections. This maximum defines a global range where the residual static corrections are sought. For example, a range between −20 ms and +20 ms around an average time for traveling through the weathering zone with a constant velocity equal to 500 m/s corresponds to a layer thickness variation of about 20 m. However, this range can be larger in case of low velocities (shear-wave for instance) or specific near-surface conditions. The global range of static correction is survey-dependent.

The use of a large global range increases the risk of introducing some cycle skips in the residual static corrections (i.e., an artificially sharp and very local variation due to connecting events which have different natures) and/or long wavelength. These cycle skips are prohibitive as they create some seismic events that do not exist in the true geology and the quality of a method strongly depends on its ability to avoid these cycle skips.

Accordingly, it is desirable to develop methods and apparatuses able to determine residual static corrections while mitigating the above-identified drawbacks of conventional methods.

### SUMMARY

Some embodiments use in-field non-survey-acquired information (e.g., geological information, up-hole survey information, information extracted from satellite maps, gravimetry measurements or a radar survey) to determine individual ranges location-by-location or for some sub-areas of the survey, before calculating residual static corrections associated with shots and/or receiver corrections.

According to an embodiment, there is a method for determining residual static corrections related to survey data acquired to explore an underground formation. The method includes determining an individual range of a residual static correction related to a location of a shot or of a receiver. The method further includes selecting traces from the survey data, with the traces corresponding to waves traveling through the underground formation from the location of the shot or to the location of the receiver, respectively. The method also includes calculating a residual static correction corresponding to the location, using the selected traces, such that the residual static correction to be within the determined individual range. Residual static corrections may be simultaneously calculated for multiple (even for all) shot and/or receiver locations.

According to another embodiment, there is a survey data processing apparatus configured to determine residual static corrections for survey data. The apparatus includes an interface configured to transmit and/or receive survey data, and a data processing unit. The data processing unit is configured to determine an individual range of a residual static correction related to a location of a shot or of a receiver, to select traces from the survey data, with the traces corresponding to waves traveling through the underground formation from the location of the shot or to the location of the receiver, respectively, and to calculate the residual static correction corresponding to the location, using the selected traces, such that the residual static correction to be within the determined individual range. Residual static corrections may be simultaneously calculated for multiple (even for all) shot and/or receiver locations.

According to yet another embodiment there is a computer-readable medium non-transitorily storing executable codes which, when executed by a computer having access to survey data, performs a method for determining residual static corrections. The method includes determining an individual range of a residual static correction related to a location of a shot or of a receiver. The method further includes selecting traces from the survey data, with the traces corresponding to waves traveling through the underground formation from the location of the shot or to the location of the receiver, respectively. The method also includes calculating a residual static correction corresponding to the location, using the selected traces, such that the residual static correction to be within the determined individual range.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a land survey setup;

FIG. 2 is a flowchart of a method according to an embodiment;

FIG. 3 illustrates different individual ranges for the residual static corrections of adjacent locations;

FIG. 4 illustrates using different individual ranges for data pertaining to different surveys;

FIG. 5 illustrates using attributes to determine individual range limits; and

FIG. 6 is a schematic diagram of a survey data processing apparatus according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to land seismic data. However, similar embodiments and methods may be used for marine survey data, and for land or marine survey data acquired using electromagnetic waves.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Some of the embodiments described in this section determine one or more individual ranges to be used while determining residual static corrections at (shot and/or receiver) location(s). In other words, a residual static correction, Shift (S), applied to any trace of waves emitted from a shot location (or to any trace of waves detected at a receiver location) is sought within an individual range, R(S), which is R(S)=[Inf(S),Sup(S)]. The range R(S) can be determined using non-survey-acquired information or any other information.

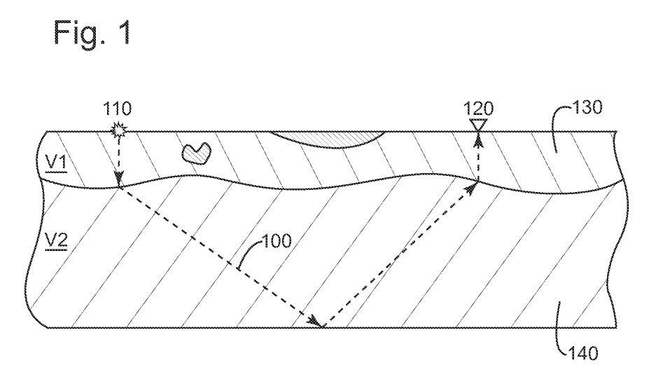

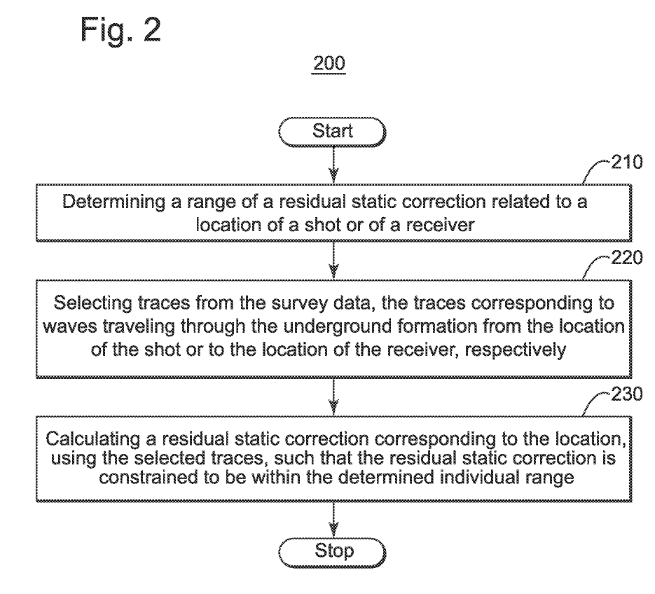

FIG. 2 is a flowchart of a method 200 according to an embodiment. Method 200 includes determining an individual range, R(S), of a residual static correction related to a location, S, of a shot or of a receiver (e.g., 110 or 120 in FIG. 1), at 210. Range R(S) may be determined using one or more of geological information, up-hole survey information, information extracted from satellite maps and non-seismic surveys. The non-seismic surveys may be gravimetry measurements and a radar survey.

Method 200 further includes selecting traces from the survey data, with the traces corresponding to waves traveling through the underground formation from or to the location S, at 220. Plural traces traveling from a shot location are selected to be used for determining the residual static correction for the shot location. Plural traces traveling to a receiver location are selected to be used for determining the residual static correction for the receiver location.

Method 200 then includes calculating a residual static correction for location S, using the selected traces, so that the residual static correction Shift (S) is to be within the determined range R(S), at 230.

Although method 200 is described as operating for one point, in fact steps 210-230 may be simultaneously applied for multiple (even for all) shot and/or receiver locations. For example, in one embodiment, for plural shots and/or receivers, individual ranges of residual static corrections are determined for locations of the shots and/or the receivers, respectively. Then, traces are selected from the survey data, the traces corresponding to waves emitted or detected at the locations. Further, residual static corrections corresponding to the locations are calculated, the residual static corrections being constrained to be within the individual ranges, respectively.

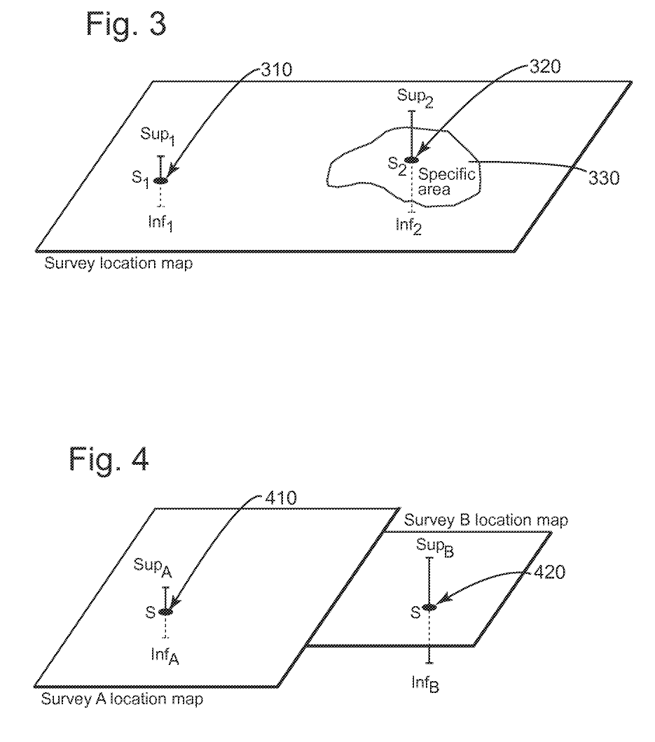

The range determined for a location may differ from ranges for adjacent locations. For example, FIG. 3 illustrates a first location S₁, 310, associated with a range R(S₁)=[Inf₁,Sup₁] adjacent to a second location S₂, 320, associated with a range R(S₂)=[Inf₂, Sup₂]. Range R(S₁) is narrower than range R(S₂) due to a local effect in area 330 (i.e., Sup₂−Inf₂>Sup₁−Inf₁). Using local ranges instead of a broad global range allows avoidance of cycle skip.

In one embodiment, a local range may characterize a sub-area (e.g., 330 in FIG. 3) of a surveyed area, with the sub-area including plural source and/or receiver locations.

A linear inversion method using cross-correlation (e.g., as described in the article entitled “Estimation and Correction of Near-Surface Time Anomalies” by M. Turhan, F. Koehler and K. A. Alhilali published in Geophysics, vol. 39, No. 4, August 1974, p. 441-463, and in the article entitled “Robust Inversion for Converted Wave Receiver Statics,” by S. Jin, et al., presented at the 74th Annual International Meeting of the Society of Exploration Geophysicists, Denver 2004) may be used to calculate the residual static correction.

Alternatively, the stack-driven non-linear method (as described, for example, in articles “Non-linear Inversion, Statistical Mechanics and Residual Statics Estimation” by Daniel H. Rothman, published in Geophysics 50, p. 2784-2796, and “Surface-Consistent Residual Statics Estimation by Stack Power Maximization” by J. Ronen and J. F. Claerbout, published in Geophysics, vol. 50, No. 12, December 1985, p. 2759-2767) may be used to calculate the residual static correction. Further, a Monte Carlo method may be used for the same purpose (as described in the article entitled “Simulated Annealing Statics Computation Using an Order-based Energy Function” by K. Vasudevan et al., published in Geophysics 56, p. 1831-1839). An overview of different methods are used for computing surface-consistent residual statics on P-P data and receiver statics on P-S data is presented in the article entitled “Static Corrections—A Review” by D. Marsden published in The Leading Edge, January 1993, p. 210-216.

The above-listed methods are not intended to be limiting, but merely exemplary. Different methods may be used for different locations depending on criteria such as (but not limited to) static ranges or signal to noise ratio.

If two surveys, A and B, are merged, the global range 410 for survey A, RA(S)=[Inf_{A},Sup_{A}] may be different from the global range 420 for survey B, R_{B}(S)=[Inf_{B},Sup_{B}] as illustrated in FIG. 4. Such differences may be due to dimensional changes (thinning or engrossing of the weathering layer) or other changes that trigger change of the wave propagation velocity (e.g., humidity) between survey A and survey B.

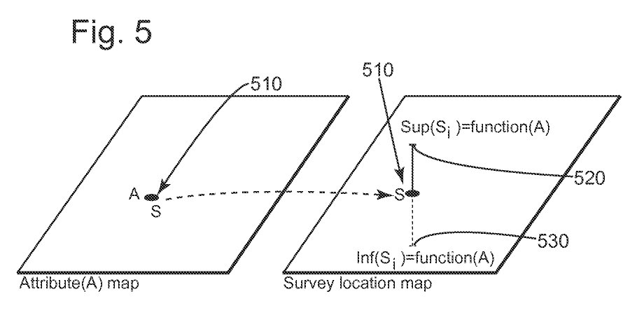

In one embodiment, range R(S) is determined based on an attribute A measured at the location S, 510 illustrated in FIG. 5. Determining the range then includes calculating at least one of a low limit 520 of the range, Inf (S), and a high limit 530 of the range, Sup (S) for the location S 510, as a function of the measured attribute A (i.e., Inf(A)=f₁(A) and/or Sup(S)=f₂(A)).

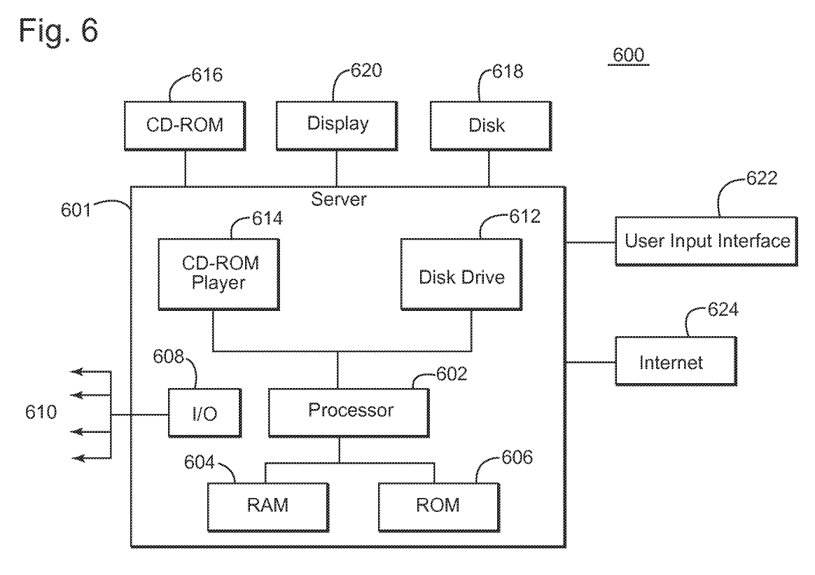

FIG. 6 illustrates a block diagram of a data processing apparatus 600 usable to perform the above-described methods for determining residual static corrections related to survey data acquired to explore an underground formation, according to an embodiment. Apparatus 600 may include server 601 having a data processing unit (including one or more processors) 602 coupled to a random access memory (RAM) 604 and to a read-only memory (ROM) 606. ROM 606 may be programmable ROM (PROM), erasable PROM (EPROM), etc. The above-described methods for determining residual static corrections related to survey data acquired to explore an underground formation may be implemented as computer programs (i.e., executable codes) non-transitorily stored on RAM 604 or ROM 606.

Data processing unit 602 may communicate with other internal and external components through input/output (I/O) circuitry 608 (i.e., interface 608) and bussing 610. Interface 608 is configured to transmit and/or receive data (survey data and other information used to determine the ranges).

Data processing unit 602 is configured to determine the range, to select the traces, and to calculate the residual static correction for multiple shot and/or receiver locations. The method used by the data processor(s) 602 to calculate the residual static correction may be linear and based on cross-correlation, or may be non-linear, stack driven.

Server 601 may also include disk drives 612, CD-ROM drives 614, and other hardware capable of reading and/or storing information, such as a DVD, etc. In one embodiment, software for carrying out the above-discussed methods may be stored and distributed on a CD-ROM 616, disk 618 or other forms of media capable of storing information. The storage media may be inserted into, and read by, devices such as the CD-ROM player 614, disk drive 612, etc.

Server 601 may be coupled to a display 620, which may be any type of known display or presentation screen, such as LCD, plasma displays, cathode ray tubes (CRT), etc. Server 601 may control display 620 to show images of the ranges, the corrections or of the explored underground formation.

A user input interface 622 may include one or more user interface mechanisms such as a mouse, keyboard, microphone, touchpad, touch screen, voice-recognition system, etc.

Server 601 may be coupled to other computing devices, such as the survey equipment, via a network. The server may be part of a larger network configuration as in a global area network such as the Internet 624.

In one embodiment, data processing unit 602 is configured to determine individual ranges, to select the traces, and to calculate the residual static corrections corresponding to multiple shot and/or receiver locations. The method used by the data processing unit 602 to calculate the residual static corrections may be linear and based on cross-correlation, or may be stack-driven and non-linear or any methods to compute residual static corrections.

The above-described embodiments integrate in-field non-survey-acquired information in determining residual static corrections. These embodiments may provide one or more of the following advantages:
better control of the manner of calculating residual static corrections in case of survey mergers, extremely heterogeneous near-surface geology, etc.;
better control of sensitive areas (e.g., salt steep flanks);
decrease in the risk of cycle skips; and
better control of the long wavelength term.

Some techniques like stack power maximization are insensitive to long-wavelength components in the residual static corrections. Providing a solution free of these long-wavelengths may be challenging. Reducing the static range in some specific areas can reduce the risk of introducing such long-wavelengths.

The disclosed exemplary embodiments provide methods and devices for determining residual static corrections related to survey data acquired to explore an underground formation, such that each residual static correction is constrained to be within a specific range. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for determining residual static corrections related to survey data acquired to explore an underground formation, the method comprising:
determining an individual range of a residual static correction related to a location of a shot or of a receiver;
selecting traces from the survey data, the selected traces corresponding to waves traveling through the underground formation from the location of the shot or to the location of the receiver, respectively; and
calculating a residual static correction corresponding to the location, using the selected traces, such that the residual static correction is constrained to be within the determined individual range.

2. The method of claim 1, wherein the determining, the selecting and the calculating are performed for multiple shot and/or receiver locations.

3. The method of claim 2, wherein at least two individual ranges for two adjacent locations are different.

4. The method of claim 2, further comprising:
applying residual corrections to a subset of survey data corresponding to the multiple shots and/or the multiple locations; and
generating an image of the underground substructure using the seismic data in which an acquired subset of the survey data corresponding to the multiple shots and/or the multiple locations is replaced by the subset to which residual corrections have been applied.

5. The method of claim 1, wherein the residual static correction is calculated using a linear method based on cross-correlation.

6. The method of claim 1, wherein the residual static correction is calculated using a stack driven non-linear method.

7. The method of claim 1, wherein the individual range of the residual static correction is determined based on one or more of geological information, up-hole survey information, satellite maps information, and a non-seismic survey.

8. The method of claim 7, wherein the non-seismic survey is one of gravimetry measurements and a radar survey.

9. The method of claim 1, wherein if first survey data and second survey data are merged, a first individual range to be used for a first residual static correction related to the location is determined for the first survey data, and a second individual range for a second residual static correction related to the location is determined for second survey data, the first and second survey data being merged after applying the first and second static correction, respectively.

10. The method of claim 1, wherein the seismic data is land seismic data.

11. The method of claim 1, wherein the determining of the individual range comprises:
measuring an attribute at the location; and
calculating at least one of a low limit of the individual range and a high limit of the individual range as a function of the measured attribute.

12. A survey data processing apparatus configured to determine residual static corrections for survey data, the apparatus comprising:
an interface configured to transmit and/or receive survey data; and
a data processing unit configured:
to determine an individual range of a residual static correction related to a location of a shot or of a receiver;
to select traces from the survey data, the selected traces corresponding to waves traveling through the underground formation from the location of the shot or to the location of the receiver, respectively; and
to calculate the residual static correction corresponding to the location, using the selected traces, such that the residual static correction is constrained to be within the determined individual range.

13. The apparatus of claim 12, wherein the data processing unit is configured to determine the individual range, to select the traces, and to calculate the residual static correction for multiple shot and/or receiver locations.

14. The apparatus of claim 12, wherein the data processing unit uses a linear cross-correlation based method for calculating the residual static correction.

15. The apparatus of claim 12, wherein the data processing unit uses a stack-driven nonlinear method for calculating the residual static correction.

16. The apparatus of claim 12, wherein the data processing unit determines the individual range of the residual static correction based on one or more of geological information, up-hole survey information, satellite maps information, gravimetry measurements and a radar survey.

17. The apparatus of claim 12, wherein, if first survey data and second survey data are merged, the data processing unit is configured to determine a first individual range of the residual static correction related to the location for the first survey data, and a second individual range of the residual static correction related to the location for the second survey data.

18. The apparatus of claim 12, wherein the data processing unit is configured to determine the individual range of the residual static correction by:
measuring an attribute at the location of a shot and of a receiver; and
calculating at least one of a low limit of the individual range and a high limit of the individual range as a function of the measured attribute.

19. A computer readable medium non-transitorily storing executable codes which, when executed by a computer having access to survey data, performs a method for determining residual static corrections, the method comprising:
determining a individual range of a residual static correction related to a location of a shot or of a receiver;
selecting traces from the survey data, the selected traces corresponding to waves traveling through the underground formation from the location of the shot or to the location of the receiver, respectively; and
calculating a residual static correction corresponding to the location, using the selected traces, such that the residual static correction is constrained to be within the determined individual range.

20. The computer readable medium of claim 19, wherein the method has at least one of following features:
the determining, the selecting and the calculating are performed for multiple shot and/or receiver locations,
the residual static correction is calculated using a linear method based on cross-correlation or a stack driven non-linear method,
the individual range of static correction is determined based on one or more of geological information, up-hole survey information, satellite maps information, gravimetry measurements and a radar survey, and
the determining of the individual range comprises measuring an attribute at the location of a shot and of a receiver and calculating at least one of a low limit of the individual range and a high limit of the individual range as a function of the measured attribute.
